(19) United States
(12) Patent Application Publication
(10) Pub. No.: US 2008/0301786 A1
(43) Pub. Date: Dec. 4, 2008

(54) Times 2 security system

(76) Inventors: Shaun Cuttill, Katy, TX (US); Gregory Salyards, Richmond, TX (US)

Correspondence Address: LAW OFFICE OF DAVID MCEWING, P.O. BOX 231324, HOUSTON, TX, 77023, US

(21) Appl. No.: 11/809,762

(22) Filed: Jun. 1, 2007

(51) Int. Cl. H04L 9/32

(52) U.S. Cl. 726/5

(57) ABSTRACT

A security system for determining whether a person is authorized to have access to a person, place or thing. The system has issued devices to authorized users that allow the user to answer multiple questions and that the correct answers may be time sensitive. The questions will ascertain whether the person has possession of an issued identification device. The system has a plurality of identification devices and each issued device has a plurality of addressable positions and each addressable position has an image and the image at one of the addressable positions on one of the assigned devices being different from the images at the same one of the addressable position on another one of the assigned devices.

### BACKGROUND OF INVENTION

1. Technical Field

The system and apparatus described in this disclosure pertains to authenticating the identity or authorization of one or more persons to have access to property, information or computer systems.

2. Related Technology

Authentication has been achieved in the past by use of passwords, PIN, and keys. Finger prints and iris scans have also been utilized. Other systems have utilized listing of rows and columns of randomly selected alpha-numeric codes which are known only to the security system and the authorized person seeking access.

### SUMMARY OF INVENTION

A method of authenticating user identification comprising verifying one or more images at an addressable position of a user possessed device wherein each addressable position is proximate to the circumference of a circle or an ellipse.

### SUMMARY OF DRAWINGS

FIG. 1 illustrates a first step in a computer image challenge.

FIG. 2 illustrates 3 user devices having multiple addressable positions.

FIG. 3 illustrates the user's response to the challenge based on the second device.

FIG. 4 illustrates a 3 part challenge.

FIG. 5 illustrates the user's response.

FIG. 6 illustrates another 3 part challenge.

FIG. 7 illustrates the user's response to the challenge.

The accompanying drawings, which are incorporated by reference and constitute part of the specification, illustrate preferred embodiments of the invention. These drawings, together with the general description of the invention given above and the detailed description of the preferred embodiments given below serve to explain the principles of the invention.

### DETAILED DESCRIPTION OF INVENTION

A security system is for determining whether a person (hereinafter “user”) is authorized to have access to a person, place or technology. Evidence of this authority may be in the form of an issued identification device. The device, along or in combination with other security tools such as passwords and PINs, authenticates the identity and authorization of the user.

An image can be one or more letters or numbers. The image may be visually distinct pattern or colors or symbol. An image can be a combination of letters, numbers, symbols and colors (all hereinafter referred to as “images”).

The system includes a plurality of separately identifiable images on individual devices. No two devices are alike. At least one of the images has a plurality of separate and addressable position. Each image can be identified by position (or “address”) on the device.

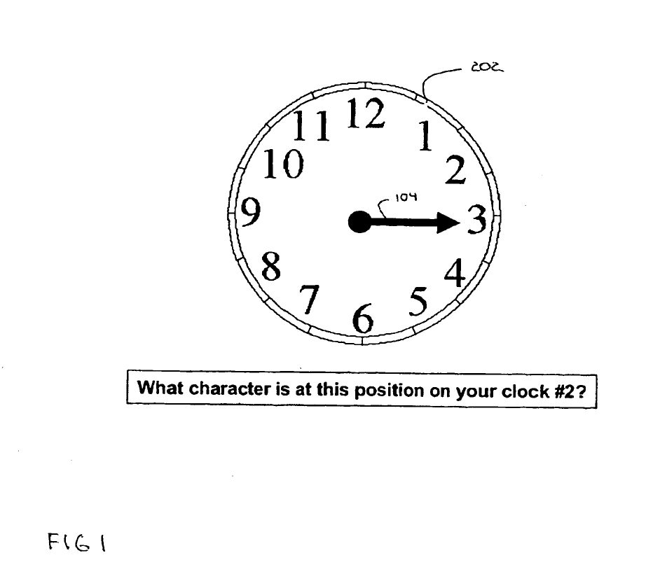

FIG. 1 challenges the user to identify the image occupying the 3 o'clock position on the user's device. Note that FIG. 1 illustrates a device 202 with a pointer 104 that is the counterpart of the device in the possession of an authorized user. The answer must match with the security challenger's device duplicating the device issued to the user. FIG. 1 is the most simplistic form of a challenge. This response type would commonly be used with a complex password and or a One-Time Password (OTP). The challenges become increasely complex. Random number generators or OTPs and PINs may be added to strengthen the response. The user may further select the type, style or color of the clock or watch to further ensure the challenging entity is more than likely the correct identity since the user would expect to always see the same image.

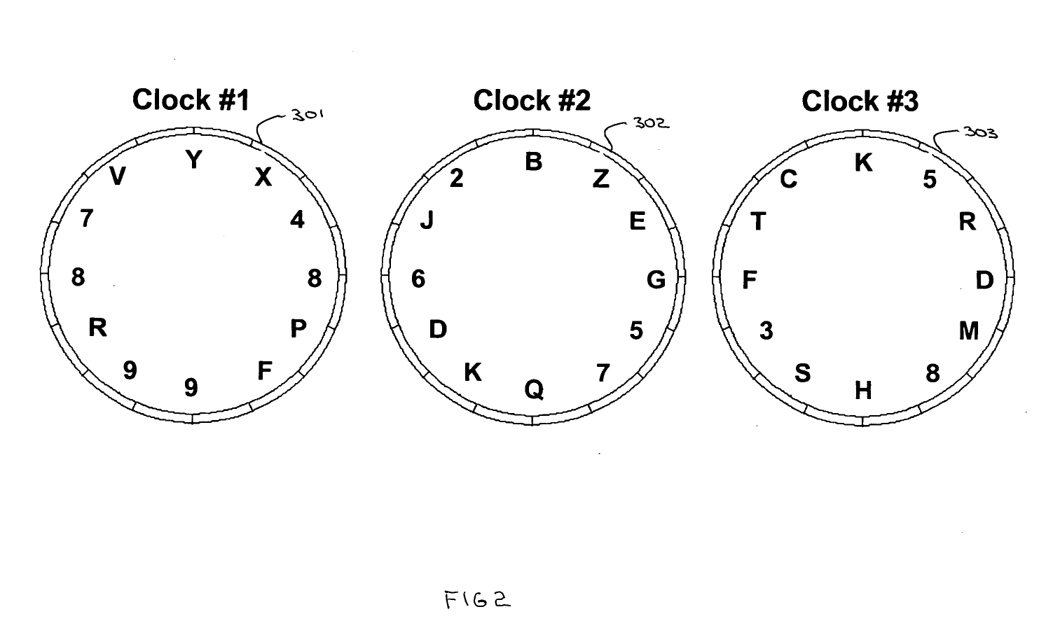

For example in FIG. 2, “clock #2, device 302, the image G occupies the 3 o'clock position. FIG. 2 illustrates an embodiment where the user has three separate devices 301, 303, 304. Each device contains multiple images placed about the periphery of the device, e.g., 351. A security challenge can be made regarding one or all of the devices.

The position can correspond to the location of numbers on a clock dial. However the device herein is not limited to 12 positions in number. Also the dial does not need to be round. The dial may be elliptical or similar shape with the addressable position of each image being proximate to the curved edge.

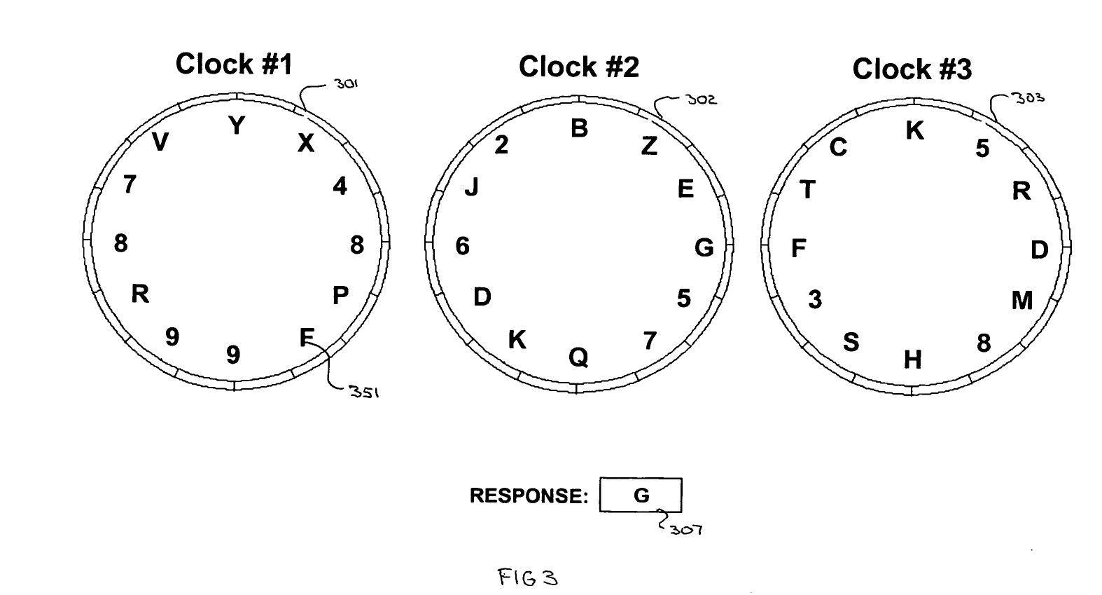

FIG. 3 includes the user's response 307 to the security challenge.

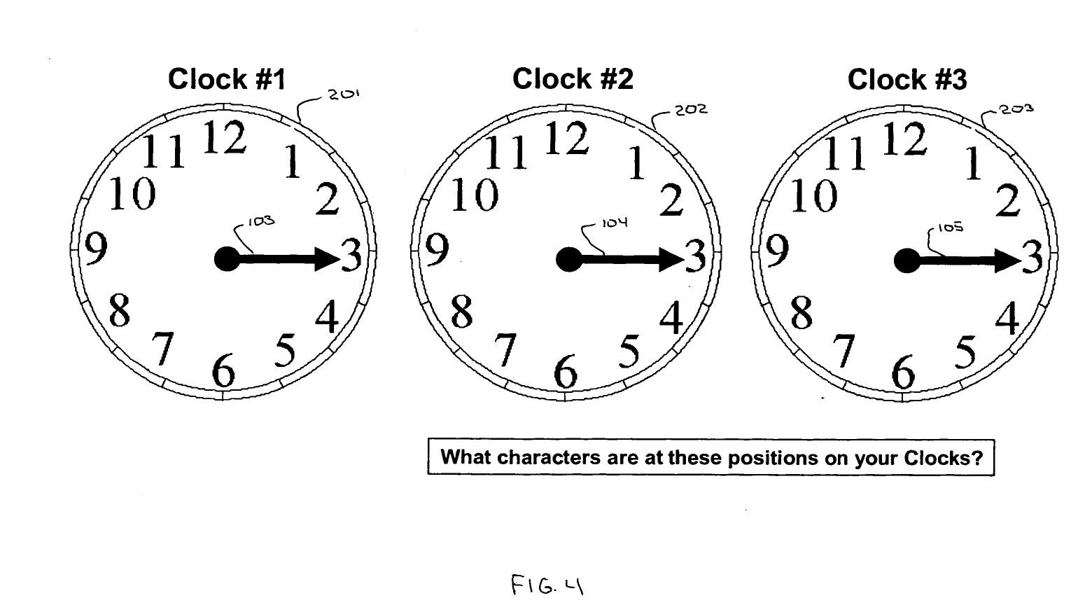

FIG. 4 issues a security challenge to the user for each of devices of the security challenger 201, 202, 203 based upon the positions of the pointers 103, 104, 105. It will be appreciated that the pointers of the user and challenger's devices are synchronized. Further it will be appreciated that the positioning and content of the images are the same for the security challenger and the user.

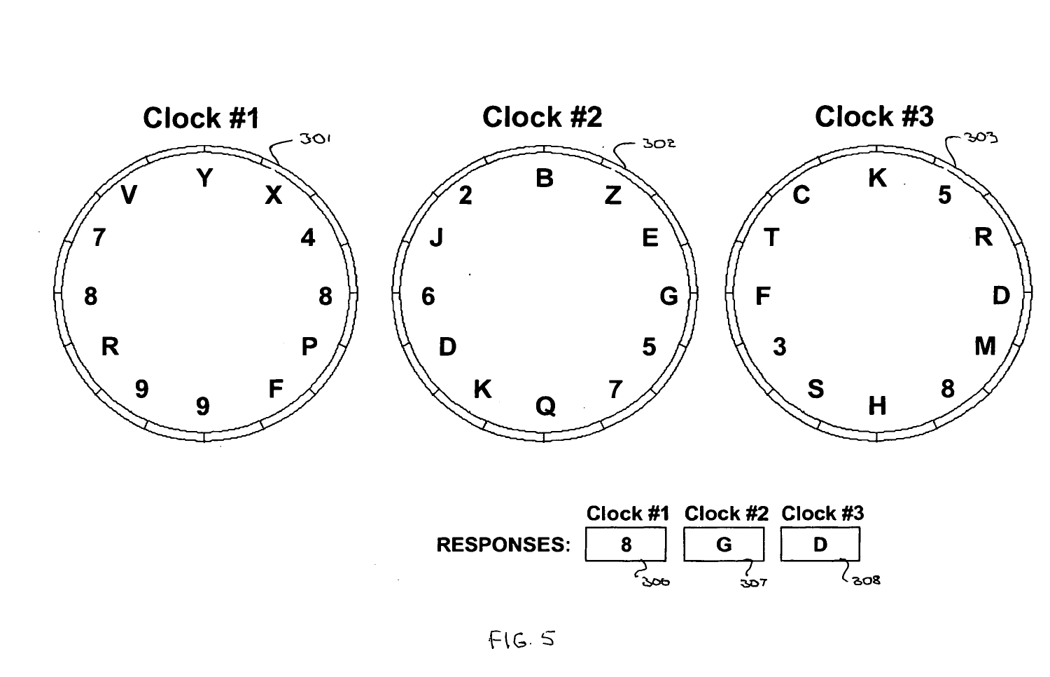

FIG. 5 illustrates the user's responses 306, 307, 308 to the security challenge.

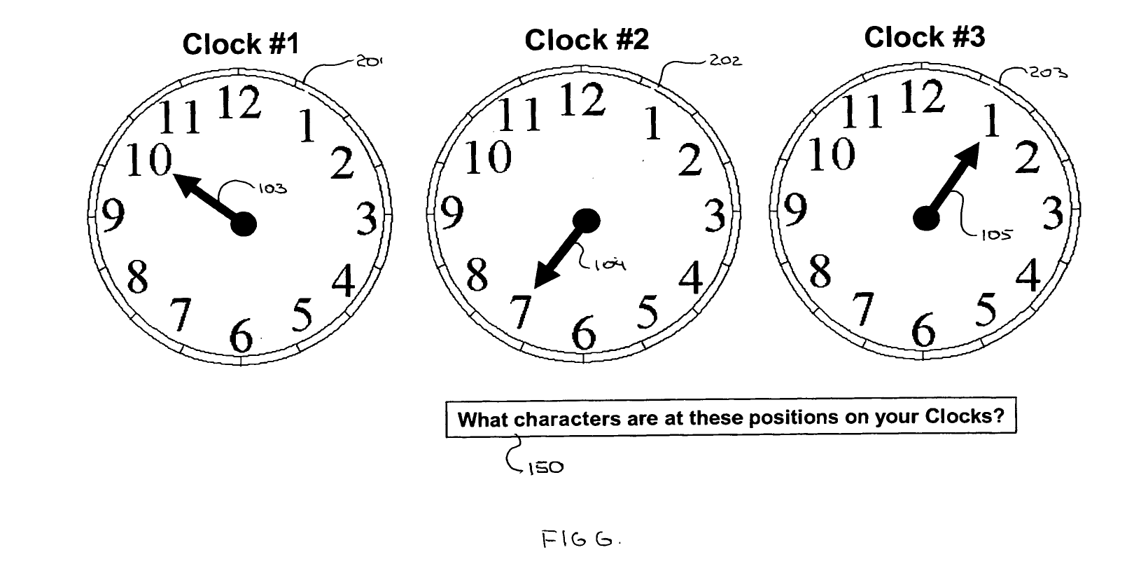

In one embodiment the device may utilize one or more moveable pointers, for example electronic or mechanical controlled. At different times, days or events the points will designate a different identifiable position. In FIG. 6, each device 201, 202, 203 has a pointer 103,104,105. These devices are in the possession of the security challenger. The challenge to the user 150 is stated in FIG. 6. Note the pointers are in different directions, unlike a clock.

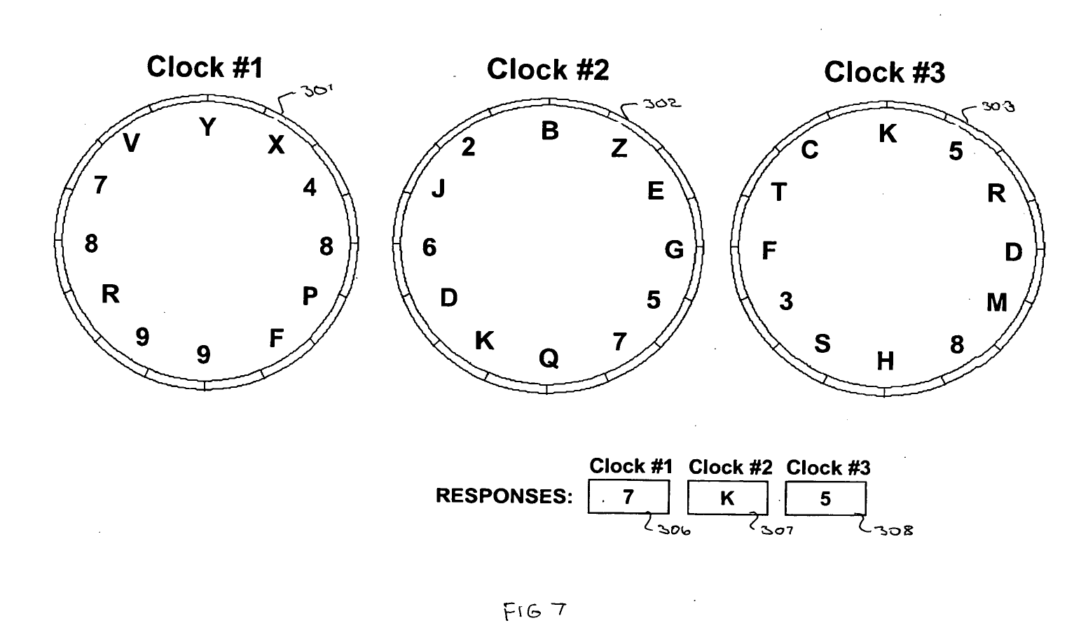

FIG. 7 illustrates the images on the user's devices 301, 302, 303. The user's response to the challenge is also illustrated 306, 307, 308.

In one embodiment, the security challenger's pointers and the pointer (not shown) included in the user's device may be synchronized. In either case, the challenger can ask the user to identify the image in a position pointed by the device. The challenger does not need to see the user's device.

There are several advantages of this embodiment of the system. The correct response to a challenge continuously changes as a function of time, event or other variable. Since the challenger is not obtaining information from the user's device similar to a computer-smart card relationship, minor variations in time keeping do not cause a defect in the system. As long as the identifiable positions can be determined, the system works. Further, the challenger and user do not need to physically meet. The system can be used in combination with passwords or PIN.

The user possesses a set of the images on a device. The set of images can be retained on an electronic device such as a handheld or PDA. Handheld devices include but are not limited to mobile phones, blackberries and the like.

The user's set of images can be used to answer or respond to a security person's challenge. Each one of a plurality of authorized persons is assigned a corresponding one of the identification images. The image at one of the addressable positions on one of the assigned images may or may not be different from the image at the same one of the addressable positions on another one of the assigned images.

As indicated, in a preferred embodiment of the invention, the addressable positions are arranged in circular patterns resembling a clock or a watch; however, images are not to form a grid or matrix pattern. The images at each of addressable positions may be different from the images at each of the addressable positions. The method for determining whether a person seeking access is authorized to obtain the requested access includes the steps: (a) distributing each one of the identification images to a corresponding one of a plurality of authorized users; (b) optionally assigning persons; (c) requesting of a person seeking access to identify themselves, provide the image at a specified one of the addressable positions is assigned to the identified person. If the image matches that assigned to the person seeking access, access is granted; otherwise access is denied.

A password or PIN may or may not also be assigned to authorized persons.

The response may or may not be applied against a traditional one-time password utilizing the assigned password or PIN.

The user possessed images may be printed or inputted as part of a digital image. The user can then call up the images on demand. It may be protected by a separate pass code or PIN.

The device may be used in internet commerce. The user enters a User ID and a Password. Security may be upgraded by creating a new PIN composed of a minimum number of digits (e.g. 6) or more. The user is also requested to select a device. In one embodiment wherein the devices are round with pointers (watch hands), the user is asked to select from a variety of clock or watch faces.

In the next step, the picture of the clock or watch may be printed or saved to the user's computer or similar device. Note the picture of the clock or watch may contain the images at the identifiable positions. The security challenge may, in one embodiment, require the user to identify the images that are in the counterpart position on the user's device. The security challenger knows the user's device. If the user answers match the security challenge, the user is authenticated.

In another embodiment of the invention, the devices may comprise a plurality of different shapes. These maybe geometric shapes, such as a circle, triangle, squares, pentagram, six pointed stars, etc. A plurality of these devices can be provided to users. At specified locations, e.g., corners, each device has an image. For a circle, the device can be marked with the points of a compass with images at the several locations. Upon challenge, the user must first correctly respond with the shape of the device and second, identify the image on the identifiable position of the device.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A method of authenticating user identification comprising verifying an image at an addressable position of a user possessed device wherein each addressable position is proximate to the circumference of a circle or an ellipse.

2. Identifying a user by comparing an image located at an addressable position proximate to the circumference of a circle or ellipse possessed by the user with information possessed by the identity challenger.

3. A security system comprising determining whether a person has possession of an issued identification device wherein the system has a plurality of identification devices and each issued device has a plurality of addressable positions and each addressable position has an image and the image at one of the addressable positions on one of the assigned devices being different from the images at the same one of the addressable position on another one of the assigned devices.

4. The system of claim 3 further comprising the arrangement of the addressable positions in a circular pattern.

5. The system of claim 3 further comprising the arrangement of the addressable positions in a non linear pattern.

6. The system of claim 3 further comprising selection of the addressable position by time.

7. The system of claim 6 comprising the calculation of time from a starting point.

8. The system of claim 6 comprising the calculation of time from the current hour of the day.

9. A method for determining access authorization comprising the steps:
a) distributing at least one identification device to at least one authorized user; and
b) requesting a person seeking access to identify themselves and provide an image at a specified addressable position on the device assigned to the identified person.

10. The method of claim 9 further comprising assigning a different password or PIN to a corresponding user.

11. The method of claim 9 further comprising the user printing the image.

12. The method of claim 9 further comprising the user recording the image.

13. The method of claim 9 further comprising arranging the addressable positions in a circular or elliptical pattern.

14. A system for authenticating the authorization of a user comprising:
(a) a plurality of different shaped devices;
(b) each device containing at least one image;
(c) the user identifying the shape of the device;
(d) the user identifying an image at an identifiable location on the device.
